(19) United States
(12) Patent Application Publication
(10) Pub. No.: US 2026/0170606 A1
(43) Pub. Date: Jun. 18, 2026

(54) METHOD AND DEVICE FOR GENERATING IMAGE

(71) Applicant: SAMSUNG ELECTRONICS CO., LTD., Suwon-si (KR)

(72) Inventors: Juyoung LEE, Suwon-si (KR); Jaeyoung MOON, Suwon-si (KR); Minjung SON, Suwon-si (KR); Nahyup KANG, Suwon-si (KR)

(73) Assignee: SAMSUNG ELECTRONICS CO., LTD., Suwon-si (KR)

(21) Appl. No.: 19/232,352

(22) Filed: Jun. 9, 2025

(30) Foreign Application Priority Data
Dec. 13, 2024 (KR) 10-2024-0186240

(51) Int. Cl. G06T 3/4053; G06T 5/77; G06V 10/40

(52) U.S. Cl. CPC G06T 3/4053; G06T 5/77; G06V 10/40

(57) ABSTRACT

A method of generating an image, including: obtaining input data based on a first image having a first resolution and a second image having a second resolution that is higher than the first resolution; generating a third image without a ghost artifact by applying one or more gated convolution operations to the input data using a kernel prediction network; generating a fourth image by upscaling the first image; and generating an output image without the ghost artifact based on the third image and the fourth image, wherein the output image has an output resolution that is higher than the first resolution

### CROSS-REFERENCE TO RELATED APPLICATIONS

This application is based on and claims priority under 35 USC § 119(a) to Korean Patent Application No. 10-2024-0186240, filed on Dec. 13, 2024, in the Korean Intellectual Property Office, the disclosure of which is incorporated by reference herein in its entirety.

### BACKGROUND

### 1. Field

The disclosure relates to a method of generating an image and a device therefor.

### 2. Description of Related Art

A real-time rendering technology may be used in computer graphics and image processing fields. For example, a technology for converting a low-resolution image into a high-resolution image, or enhancing the visual quality within limited computational resources may be important in various applications.

When resolution is increased by spatially interpolating pixel data of a low-resolution image, fine details may be insufficient or image distortion may occur. A method of reflecting temporal continuity may enhance the visual quality by using data of a previous frame, but may cause a ghost artifact in a disocclusion area in which the previous data is invalid.

Some approaches use deep learning-based technology to learn multiple images and restore complex patterns or details based thereon. However, in an image that rapidly moves or has a significant change in a viewpoint, continuous pixel matching may be difficult, and distortion or a ghost artifact may therefore be noticeable. Accordingly, there is a need for a method of effectively removing a ghost artifact and maximizing the computational efficiency in a real-time environment.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an aspect of the disclosure, a method of generating an image includes: obtaining input data based on a first image having a first resolution and a second image having a second resolution that is higher than the first resolution; generating a third image without a ghost artifact by applying one or more gated convolution operations to the input data using a kernel prediction network; generating a fourth image by upscaling the first image; and generating an output image without the ghost artifact based on the third image and the fourth image, wherein the output image has an output resolution that is higher than the first resolution.

The one or more gated convolution operations may include one or more dilated convolution operations.

The one or more gated convolution operations may include operations for performing gating processing using at least one of a rectified linear unit (ReLU) function and a sigmoid function.

The obtaining of the input data may include: obtaining first input data and second input data based on the first image and the second image; providing the first input data as input to a feature path included in in the one or more gated convolution operations; and providing the second input data as input to a gating path included in in the one or more gated convolution operations.

The first input data may include geometric information extracted from a rendering result associated with the first image.

The second input data may include a difference value indicating a difference between the first image and an image that is obtained by warping a viewpoint of the second image to correspond to a viewpoint of the first image and transforming a resolution of the second image to correspond to a resolution of the first image.

The obtaining of the input data may include: obtaining first feature data and second feature data by extracting a feature from the first image and extracting a second feature from the second image.

The applying of the one or more gated convolution operations may include: warping the second feature data; and providing the warped second feature data as input to a gating path.

The applying of the one or more gated convolution operations may include: performing a concatenation operation on a feature path; and performing a cross-correlation operation on the gating path.

The obtaining of the input data may include: transforming the first image into a first grayscale image and transforming the second image into a second grayscale image; and generating the input data based on the second grayscale image and the first grayscale image, and the first grayscale image and the second grayscale image may be space-to-depth transformed.

The generating of the output image without the ghost artifact may include: obtaining a first high-resolution image by performing a depth-to-space transformation operation on the third image.

The generating of the output image without the ghost artifact may include: obtaining a weighted sum of the first high-resolution image, the fourth image, and the second grayscale image.

In accordance with an aspect of the disclosure, an electronic device includes: one or more processors; and a memory configured to store instructions which, when executed by the one or more processors, cause the electronic device to: obtain input data based on a first image having a first resolution and a second image having a second resolution that is higher than the first resolution, generate a third image without a ghost artifact by applying one or more gated convolution operations to the input data using a kernel prediction network, generate a fourth image by upscaling the first image, and generate an output image without the ghost artifact based on the third image and the fourth image, wherein the output image has an output resolution that is higher than the first resolution.

The one or more gated convolution operations may include one or more dilated convolution operations.

The one or more gated convolution operations may include operations for performing gating processing using at least one of a rectified linear unit (ReLU) function and a sigmoid function.

The instructions, when executed by the one or more processors, may further cause the electronic device to: obtain first input data and second input data based on the first image and the second image, provide the first input data as input to a feature path included in in the one or more gated convolution operations, and provide the second input data as input to a gating path included in in the one or more gated convolution operations.

The first input data may include geometric information extracted from a rendering result associated with the first image.

The second input data may include a difference value indicating a difference between the first image and an image that is obtained by warping a viewpoint of the second image to correspond to a viewpoint of the first image and transforming a resolution of the second image to correspond to a resolution of the first image.

The instructions, when executed by the one or more processors, may further cause the electronic device to: obtain first feature data and second feature data by extracting a first feature from the first image and extracting a second feature from the second image.

In accordance with an aspect of the disclosure, a terminal device includes: an output device configured to display a real-time rendered image; and one or more processors configured to perform real-time rendering, a memory configured to store instructions which, when executed by the one or more processors, cause the terminal device to: generate an image for removing a ghost artifact from the real-time rendering, and display an output image without the ghost artifact on the output device, wherein to generate the image for removing the ghost artifact from the real-time rendering, the instructions, when executed by the one or more processors, further cause the terminal device to: obtain input data based on a first image having a first resolution and a second image having a second resolution that is higher than the first resolution; generate a third image without the ghost artifact by applying one or more gated convolution operations to the input data using a kernel prediction network; generate a fourth image by upscaling the first image; and generate the output image without the ghost artifact based on the third image and the fourth image, wherein the output image has an output resolution that is higher than the first resolution.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic flowchart illustrating an image generation method according to an embodiment;

FIG. 2 is a diagram schematically illustrating a super-sampling network according to an embodiment;

FIG. 3 is a block diagram schematically illustrating an operation of a kernel prediction network according to an embodiment;

FIG. 4A is a schematic diagram illustrating an example of gated convolution according to an embodiment;

FIG. 4B is a schematic diagram illustrating an example of standard convolution according to an embodiment;

FIG. 4C is a schematic diagram illustrating an example of dilated convolution according to an embodiment;

FIG. 5 is a block diagram schematically illustrating a deformed gated convolution operation according to an embodiment;

FIG. 6 is a block diagram schematically illustrating a deformed gated convolution operation according to an embodiment;

FIG. 7 schematically illustrates a process of deforming an input of a gated convolution operation and performing the operation according to an embodiment;

FIG. 8 is a schematic block diagram illustrating a method of applying warping in a feature domain according to an embodiment;

FIG. 9 is a diagram schematically illustrating a gated convolution to which a correlation operation is added according to an embodiment;

FIG. 10 is a block diagram of an electronic device according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

Although terms, such as first, second, and the like are used to describe various components, the components are not limited to the terms. These terms are used only to distinguish one component from another component. For example, a first component may be referred to as a second component, and similarly, the second component may also be referred to as the first component.

It should be noted that one component is described as being “connected”, “coupled”, or “joined” to another component, this may mean that a third component may be “connected”, “coupled”, and “joined” between the first and second components, or that the first component may be directly “connected”, “coupled”, or “joined” to the second component without another intervening component therebetween.

As used herein, the singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. As used herein, expressions such as “at least one of,” when preceding a list of elements, modify the entire list of elements and do not modify the individual elements of the list. For example, the expression, “at least one of A, B, and C,” should be understood as including only A, only B, only C, both A and B, both A and C, both B and C, or all of A, B, and C.

Unless otherwise defined, all terms, including technical and scientific terms, used herein have the same meaning as commonly understood by one of ordinary skill in the art to which the present disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

The examples may be implemented as various types of products, such as, for example, a personal computer (PC), a laptop computer, a tablet computer, a smart phone, a television (TV), a smart home appliance, an intelligent vehicle, a kiosk, and a wearable device. Hereinafter, embodiments will be described in detail with reference to the accompanying drawings. When describing the embodiments with reference to the accompanying drawings, like reference numerals refer to like elements and a repeated description related thereto will be omitted.

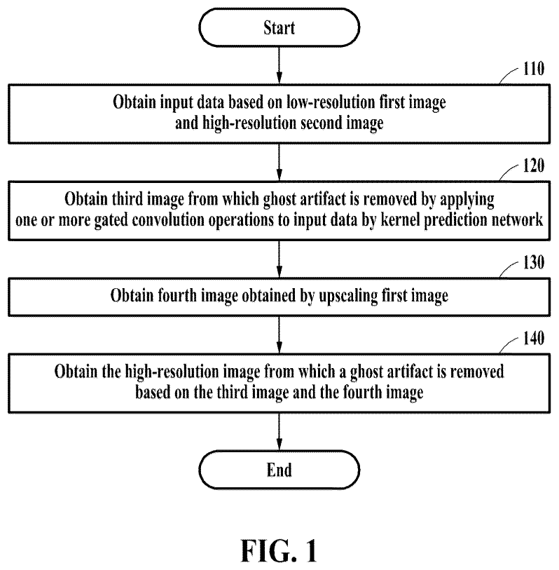

FIG. 1 is a schematic flowchart illustrating an image generation method according to an embodiment.

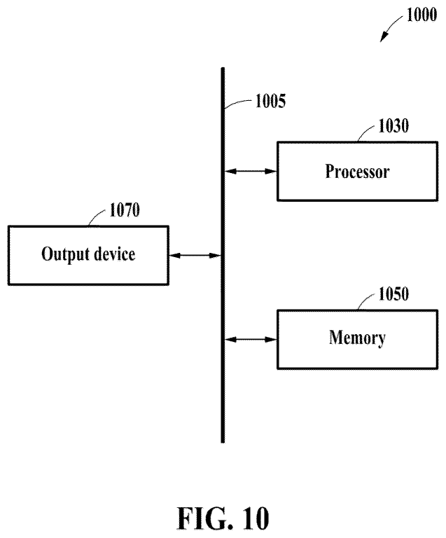

For ease of description, operations 110 to 140 are described as being performed using an electronic device 1000 shown in FIG. 10. However, operations 110 to 140 may be performed by any other appropriate electronic device and in any other appropriate system.

Furthermore, operations are described as being performed in the sequence and manner illustrated in FIG. 1. However, the order of some operations may be changed, and some of the operations may be omitted, without departing from the spirit and scope of the illustrative examples described. The operations shown in FIG. 1 may be performed in parallel or simultaneously.

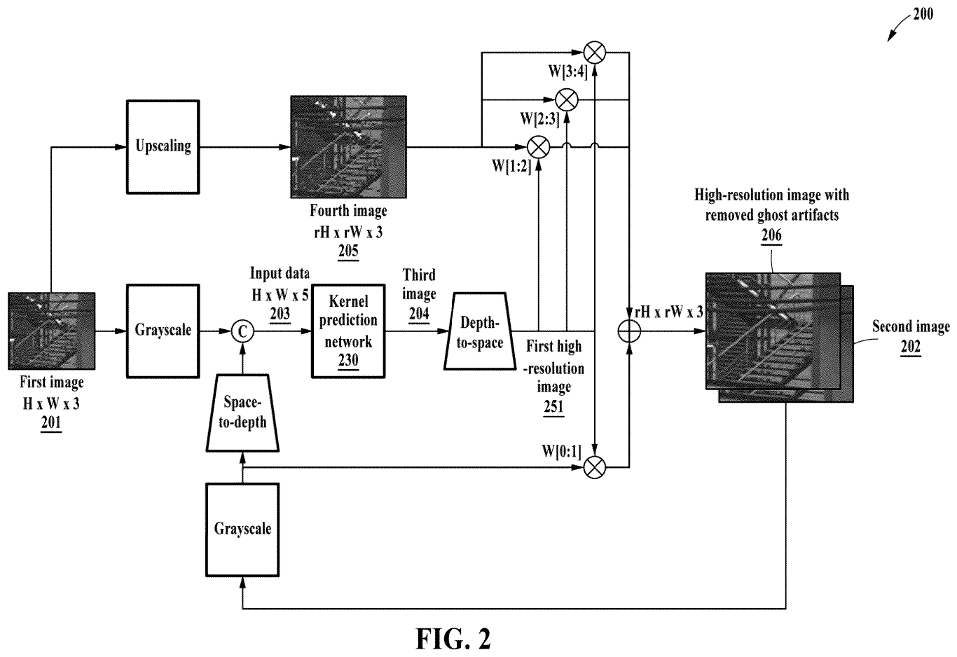

FIG. 2 is a diagram schematically illustrating a super-sampling network according to an embodiment.

An example of a process 100 illustrated in FIG. 1 is described in detail below with reference to a super-sampling network 200 illustrated in FIG. 2.

The electronic device 1000 (an example of which is described below with reference to FIG. 10) according to an embodiment may drive the super-sampling network 200. The super-sampling network 200 may generate a high-resolution image based on low-resolution input data and may effectively remove a ghost artifact. In some embodiments, the high-resolution image may be referred to as an output image without a ghost artifact, and a resolution of the output image may be referred to as an output resolution, which may be higher than a low resolution corresponding to the low-resolution data. According to embodiments, the super-sampling network may include four steps, for example obtaining input data, performing computations using a kernel prediction network 230, upscaling, and generating a final result.

A ghost artifact may refer to a representative problem that occurs during rendering, and may usually appear in a disocclusion area. The disocclusion area may be an area in which an occluded object in a particular frame appears in a next frame. During this process, the information of a previous frame may be incorrectly referenced, and a ghost artifact (e.g., a pixel that does not originally exist in a current frame) may remain and appear in a distorted form. For example, a phenomenon in which a trace of a car that rapidly moves may faintly remain in a current frame may be an example of the ghost artifact. The ghost artifact may deteriorate the user experience and may also adversely affect the quality of image processing.

At operation 110, the electronic device 1000 may obtain input data 203 based on a low-resolution first image 201 and a high-resolution second image 202 According to embodiments, a resolution of the first image 201 may be referred to as a first resolution, and a resolution of the second image 202 may be referred to as a second resolution that is higher than the first resolution.

The electronic device 1000 according to an embodiment may transform the first image 201 and the second image 202 into a first grayscale image and a second grayscale image. For example, the electronic device 1000 according to an embodiment may transform the first image 201 into a first grayscale image, and may transform the second image 202 into a second grayscale image. The electronic device 1000 may generate the input data 203 based on a space-to-depth transformed second grayscale image and the first grayscale image.

According to embodiments, the first image 201 may be a low-resolution image at a current time (or frame), and may be represented as LR(t). The second image 202 may be a high-resolution image on which super-sampling is performed at a previous time (or frame), and may be represented as HR(t−1). A final target result, which may be a high-resolution image 206 from which a ghost artifact is removed, may be represented as HR(t). According to embodiments, the high-resolution image 206 may be referred to as an output image without a ghost artifact, and a resolution of the high-resolution image 206 may be referred to as an output resolution, which may be higher than the first resolution corresponding to the first image 201.

For example, the first image 201 may be a low-resolution color image having a size of H×W×3, and may be transformed into the first grayscale image using grayscale transformation. In addition, the high-resolution second image 202 may also be transformed into the second grayscale image using the grayscale transformation. The electronic device 1000 may adjust the second grayscale image to correspond to the resolution of the low-resolution image (e.g., the first resolution) by performing a space-to-depth transformation operation on the second grayscale image. For example, if the second grayscale image is divided into four channels, the electronic device 1000 may divide the high-resolution second image 202 into four channels and may allocate spatial information to each channel rather than reducing the spatial resolution of the high-resolution second image 202. In this process, the second grayscale image may have a resolution corresponding to the low-resolution first image 201, and the information may simultaneously be rearranged in a channel direction. Accordingly, the second grayscale image may be transformed into data having a size of H×W×4, and may be combined with the first grayscale image.

Thereafter, the electronic device 1000 may generate the input data 203 having a size of H×W×5 by combining the first grayscale image H×W×1 with the second grayscale image H×W×4 on which the space-to-depth operation is performed. The input data 203 may be transmitted to (or provided as input to) the kernel prediction network 230.

At operation 120, the electronic device 1000 may obtain a third image 204 from which a ghost artifact is removed (e.g., a third image 204 without the ghost artifact) by applying one or more gated convolution operations to the input data 203 using the kernel prediction network 230. The kernel prediction network 230 may generate a kernel to effectively remove the ghost artifact by receiving the input data 203, and an image quality of the high-resolution image 206 may therefore be enhanced.

According to an embodiment, the one or more gated convolution operations may include one or more dilated convolution operations. Unlike standard convolution operations, the dilated convolution operations may perform an operation with a gap between filters to expand a receptive field. For example, wide area information may be collected while maintaining a relatively small kernel size, and thereby, an effective operation may be allowed in an area with high probability of including a ghost artifact, such as the disocclusion area described above.

According to an embodiment, the one or more gated convolution operation may perform gating processing using at least one of a rectified linear unit (ReLU) and a sigmoid function. For example, the ReLU function may transform a negative number into a number having a value of zero (“0”), and may pass a positive number, and the sigmoid function may emphasize information of a particular area by compressing an input value between a value of zero (“0”) and a value of one (“1”). The gating processing may contribute to removing a ghost artifact, and generating a clean image by selectively activating or deactivating a specific portion of the input data 203.

The kernel prediction network 230 may generate the third image 204 using the gated convolution operations and the dilated convolution operations.

At operation 130, the electronic device 1000 may obtain a fourth image 205 by upscaling the first image 201. For example, the upscaling may include adjacent pixel upscaling and may be used to augment the first image 201 to correspond to a resolution of a target result (e.g., an output resolution of the high-resolution image 206). The adjacent pixel upscaling may be a process for upscaling pixels of an original low-resolution image to a higher resolution by expanding the pixels using interpolation with adjacent pixel values.

For example, when the first image 201 has a size of H×W×3, the image may be transformed to have a size of rH×rW×3 using the upscaling process, where r denotes a scaling factor. In this case, the adjacent pixel upscaling may be a process for generating high-resolution by simply enlarging pixels, and may generate a smooth image by copying or interpolating color information of each pixel to an adjacent high-resolution pixel.

At operation 140, the electronic device 1000 may obtain the high-resolution image 206 from which a ghost artifact is removed (e.g., the high-resolution image 206 without the ghost artifact) based on the third image 204 and the fourth image 205.

The electronic device 1000 according to an embodiment may obtain a first high-resolution image 251 by performing a depth-to-space transformation operation on the third image 204.

The depth-to-space transformation operation may include a process for transforming the third image 204 into high resolution by spatially expanding a depth information channel of the third image 204. When the third image 204 is a low-resolution image with removed ghost artifacts, the third image 204 may be expanded into a high-resolution image using the depth-to-space transformation operation.

The depth-to-space transformation operation may include a process for reverting the previous space-to-depth transformation and the electronic device 1000 may transform into a high-resolution image by spatially rearranging the information distributed in a channel direction.

For example, when the space-to-depth transformation operation is used to transform a low resolution of H×W×4 by dividing a high-resolution image into four channels, the depth-to-space transformation operation may be used to restore the four-channel data to the original high resolution. For example, the high-resolution image may be generated by reconstructing the data having the size of H×W×4 to the form of rH×rW×1.

The electronic device 1000 according to an embodiment may obtain the high-resolution image 206 with removed ghost artifacts based on or using a weighted sum of the first high-resolution image 251, the fourth image 205, and the second grayscale image. In this case, each weight may be divided into W[0:1], W[1:2], W[2:3], and W[3:4] as illustrated for example in FIG. 2, and may be used as a factor to adjust the contribution when combining the first high-resolution image 251 with another image.

W[0:1] may be a weight applied to combine the first high-resolution image 251 with the second grayscale image. For example, the overall color balance may be adjusted by adjusting the high-resolution image and the brightness information.

W[1:2], W[2:3], and W[3:4] may be weights applied to red green blue (RGB) values of the first high-resolution image 251 and the fourth image 205, respectively, and may be used to adjust the color balance of the first high-resolution image 251 and the fourth image 205. The electronic device 1000 may generate the high-resolution image through a weighted sum for each RGB channel.

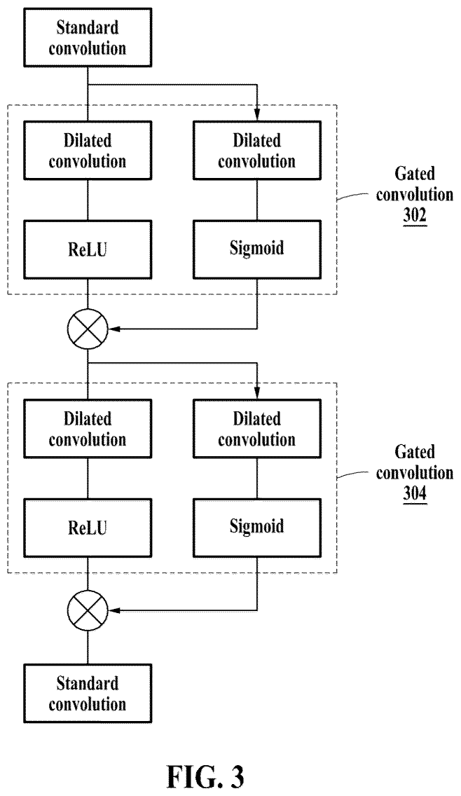

FIG. 3 is a block diagram schematically illustrating an operation of a kernel prediction network according to an embodiment.

The description provided with reference to FIGS. 1 and 2 may apply to the example of FIG. 3, and a repeated description may be omitted.

One or more blocks of FIG. 3 or a combination thereof may be implemented using a special-purpose hardware-based computer configured to perform a specific function or a combination of computer instructions and special-purpose hardware.

The electronic device 1000 may perform rendering in real-time by using gated convolution and dilated convolution to resolve a ghost artifact included in an input image using a kernel prediction network (e.g., the kernel prediction network 230 of FIG. 2). For example, according to embodiments, the electronic device 1000 may use any of the convolution operations described below with reference to FIGS. 3-9 as part of the kernel prediction network (e.g., the kernel prediction network 230 of FIG. 2).

Referring to FIG. 3, gated convolution may operate by combining values calculated by each layer using two convolutional layers to which different weights are applied for input data. A standard convolutional layer may receive input data (e.g., five channels), may perform an operation with a 3×3 kernel size, and each layer may generate data extended to thirty-two channels. The output of the standard convolutional layer may be provided as input to a gated convolution 302. A non-linear feature may be assigned to an output value of each layer using a ReLU function and a sigmoid function, and finally, output data of the gated convolution 302 may be generated by multiplying output values of the two functions.

According to embodiments, the dilated convolution may have a wide receptive field while maintaining the number of total parameters by applying zero-padding to a convolution filter. For example, even if the 3×3 sized filter is used, information about a wider area may be collected at once by spacing a gap between filters. The wider receptive field may be advantageous to predicting a more accurate pixel value by referring to a wider adjacent area.

As shown in FIG. 3, the output of the gated convolution 302 may then be provided to another gated convolution 304. In the example shown in FIG. 3, performing the gated convolution twice (e.g., performing both the gated convolution operation 302 and the gated convolution operation 304) is provided only as an example, and embodiments are not limited thereto. For example in some embodiments, one or more gated convolutions may be performed. According to embodiments, any of the convolutions described herein with reference to FIG. 3-9 may be referred to as a convolution operation. For example, the gated convolution 302 and the gated convolution 304 may be referred to as a gated convolution operation.

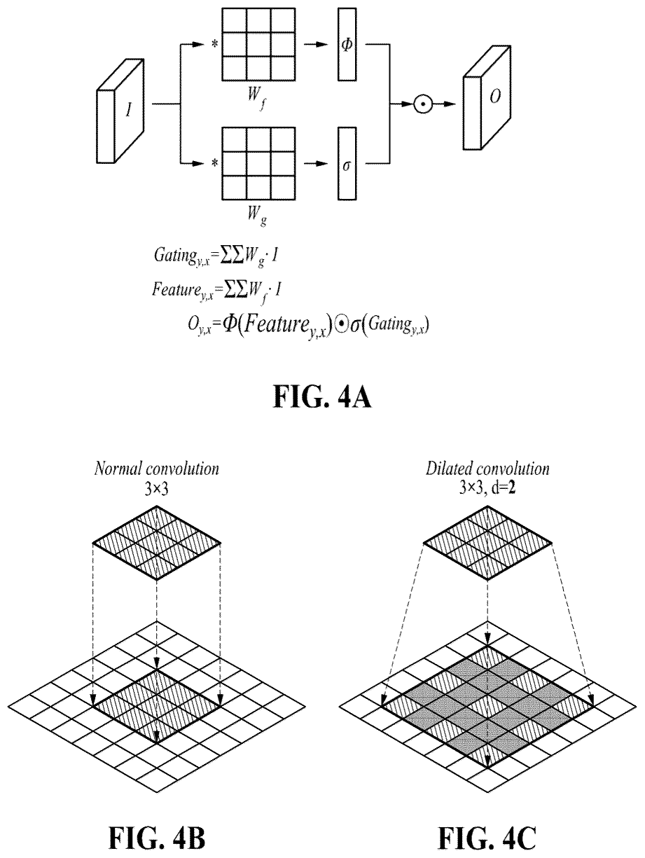

FIGS. 4A-4C are schematic diagrams illustrating examples of gated convolution, standard convolution, and dilated convolution, according to embodiments.

The description provided with reference to FIGS. 1 to 3 may apply to the examples of FIGS. 4A-4C, and a repeated description may be omitted.

Referring to FIG. 4A, a gated convolution may apply two different convolution filters, for example a feature convolution filter W_{f} and a gating convolution filter W_{g}, to input data I, and may calculate each result independently.

W_{f} may denote a weight parameter of a feature path, and may be used to calculate a feature value of a corresponding area by extracting detailed information from the input data, and may be used to generate a feature output Feature_{y,x}.

W_{g} may denote a weight parameter of a gating path, and may learn the importance of a specific area to determine how much the area should contribute to remove a ghost artifact, and may be used to generate a gating output Gating_{y,x}.

Nonlinear transformation may be applied to Feature_{y,x} and Gating_{y,x} calculated in each path through the ReLU and sigmoid activation functions, respectively. For example, a ReLU function Φ may be applied to the feature output Feature_{y,x}, and a sigmoid function σ may be applied to the gating output Gating_{y,x}. Thereafter, the two output values generated by these functions may be combined through element-wise multiplication (⊙) and a final output O_{y,x} may be generated. For example, in a specific disocclusion area, a value of Gating_{y,x} may increase, and thereby, pixels in the area may be trained to play a more important role in removing a ghost artifact.

Dilated convolution may operate to widen a receptive field of the input data by adding a gap between convolution filters (e.g., dilating the kernel by adding gaps between weights in the kernel). FIG. 4B shows an example of a standard convolution operation performed using a 3×3 filter (e.g., a filter with a 3×3 filter kernel), and FIG. 4C shows an example of a dilated convolution performed using a 3×3 filter with a padding parameter d set to d=2.

In the standard convolution shown in FIG. 4B, each of the weights or elements included in the 3×3 filter kernel may perform an operation on consecutive pixels, so that information may be collected in a narrow receptive field. However, in the dilated convolution shown in FIG. 4C, zero-padding may be applied between each of the weights or elements included in the 3×3 filter kernel to widen a filter gap so that adjacent pixel information may be widely collected. For example, in the dilated convolution shown in FIG. 4C, in which the padding parameter d is set to d=2, because the filter may perform an operation by skipping one space, the receptive field may be widened and a relationship between distant pixels may be more effectively reflected.

This characteristic of the dilated convolution may be used in an area in which the information about adjacent pixels is insufficient, such as the disocclusion area. For example, pixel information around an object that rapidly moves may be collected over a wider range to reduce ghost artifacts and a more natural pixel value may be generated.

According to embodiments, the gated convolution may learn the importance of a specific area and the dilated convolution may contribute to predicting an accurate pixel value using wide surrounding information. By combining the two operations, a ghost artifact in the disocclusion area may be effectively removed, and a high-quality rendering result may be generated in real-time.

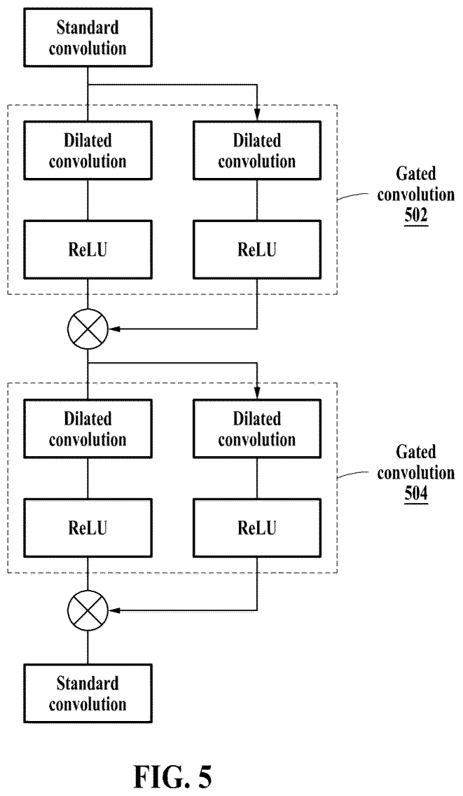

FIG. 5 is a block diagram schematically illustrating a deformed gated convolution operation according to an embodiment.

The description provided with reference to FIGS. 1 to 4 may apply to the example of FIG. 5, and a repeated description may be omitted.

According to an embodiment, a gated convolution operation may perform gating processing using at least one of a ReLU function or a sigmoid function. For example, the ReLU function may convert a negative number into a number having a value of zero (“0”) and may pass a positive number, and the sigmoid function may emphasize information of a specific area by compressing an input value between a value of zero (“0”) and a value of one (“1”). In this case, by applying the ReLU function to gating processing, the computational amount may be reduced while effectively removing a ghost artifact.

Referring to FIG. 5, input data may include five channels. A convolutional layer (e.g., standard convolution) may be used to generate feature data expanded to thirty-two channels by applying a 3×3 kernel and dilated convolution.

In the gated convolution 502, a gating path may learn the importance of a specific area and may perform gating processing using a ReLU activation function. In this case, using ReLU instead of the sigmoid function (e.g., as shown in the example of FIG. 3) may allow the amount of computations to be further reduced while maintaining the output image quality at a similar level. An output of the gating path may be combined with data of a feature path using multiplication.

Thereafter, an additional gated convolution 504 may be performed. An optimal feature may be derived from second feature data through ReLU activation. Lastly, output channels may be reduced to sixteen by applying 1×1 convolution and ultimately kernel data for removing a ghost artifact may be generated.

In the example of FIG. 5, the amount of computations may be reduced by changing an activation function applied to the gating path from sigmoid to ReLU.

Accordingly, the kernel prediction network of FIG. 5 may effectively remove a ghost artifact in the disocclusion area while maximizing the computational efficiency using the ReLU activation function.

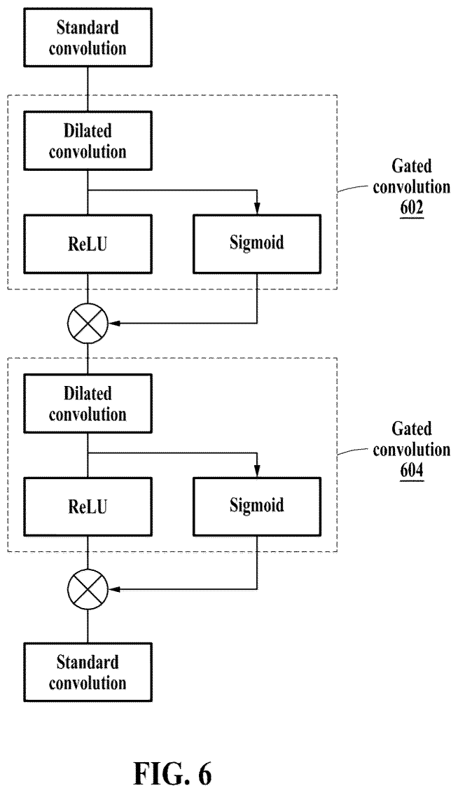

FIG. 6 is a block diagram schematically illustrating a deformed gated convolution operation according to an embodiment.

The description provided with reference to FIGS. 1 to 5 may apply to the example of FIG. 6, and a repeated description may be omitted.

Referring to FIG. 6, when the number of gating channels is reduced to one from an existing multi-channel structure, the computational amount of gated convolution may be reduced. Data having five input channels may be expanded to thirty-two channels using 3×3 dilated convolution in a convolutional layer (e.g., standard convolution), and then provided to a gated convolution 502. In this process, in a feature path, thirty-one channels may pass the ReLU activation function and nonlinear transformation may be applied thereto. In a gating path, after the number of channels is reduced to one, a gating channel may be generated by applying the sigmoid activation function thereto.

An output value (e.g., in which the number of channels is one) of the gating channel may be combined with the feature data with thirty-one channels computed in the feature path by multiplication and may apply a gating effect. Accordingly, an effect of gated convolution may be maintained while reducing the computational amount.

Similarly, in a second gated convolution 604, a 3×3 dilated convolution may be used to process the input data and the gating channel may remain as one channel again. The gating channel may be combined with the data of the second feature path and the final feature data may be generated. Lastly, final kernel data may be generated by reducing the number of channels to sixteen using 1×1 convolution.

The structure shown in FIG. 6 may be used to remove a ghost artifact by maintaining advantages of the gated convolution and the dilated convolution while increasing the computational efficiency by reducing the number of gating channels to one. Additionally, reducing the number of channels to one is an example and the number of channels may be reduced to two or more.

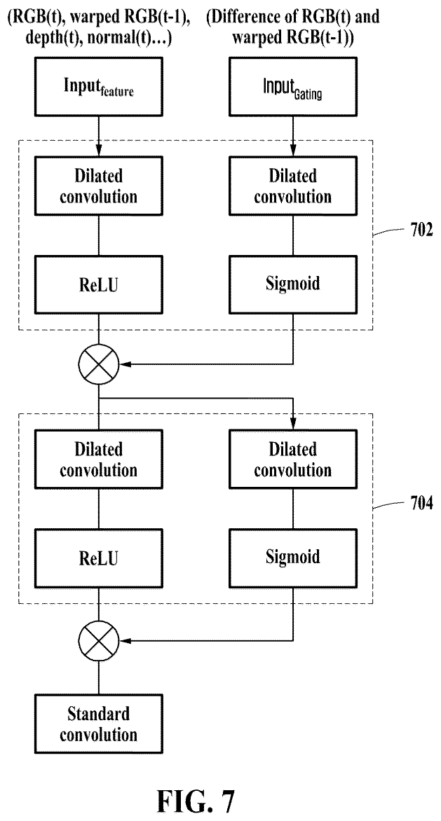

FIG. 7 schematically illustrates a process of deforming an input of a gated convolution operation and performing the operation according to an embodiment.

The description provided with reference to FIGS. 1 to 6 may apply to the example of FIG. 7, and a repeated description may be omitted.

The electronic device 1000 according to an embodiment may obtain first input data (e.g., Input_{feature}) that is input to a feature path in one or more gated convolution operations (e.g., a gated convolution 702 and a gated convolution 704) based on a first image and a second image, and may obtain second input data (e.g., Input_{Gating}) that is input to a gating path in the one or more gated convolution operations.

The first input data may include geometric information extracted from a rendering result of the first image.

The second input data may be data including a difference value indicating a difference between the first image and an image obtained by warping a viewpoint of the second image to correspond to a viewpoint of the first image and transforming the resolution of the second image to correspond to the resolution of the first image.

The feature path may receive the first input data as an input. According to embodiments, the first input data may include, for example, a low-resolution rendering RGB image at a time point t that may represent a low-resolution RGB image rendered at a current time point and may be included in the first input data. The first input data may further include, for example, a high-resolution RGB image at a time point t−1, that may be an image obtained by warping, at the time point t, a high-resolution image generated at a previous time point and transforming to low-resolution. In addition, for the geometric information depth and normal information, depth information and surface normal information included in the low-resolution image rendered at the time point t may be added. The information may be used as information to pixel compensation and ghost artifact removal in the disocclusion area.

The gating path of the gated convolution 702 may receive the second input data as an input. The second input data may include a difference value between a low-resolution rendering RGB image at the time point t, and an image obtained by warping a high-resolution RGB image at the time point t−1 to at the time point t and transforming to low-resolution. The electronic device 1000 may learn the difference in the disocclusion area using the second input data.

Based on the input data of each of the feature path and the gating path, in the feature path, the gated convolution 702 may widen the receptive field by applying the dilated convolution to the first input data and may assign a nonlinear feature through the ReLU activation function. In the gating path, the gated convolution 702 may generate a gating value of each pixel by applying the dilated convolution and the sigmoid activation function to the second input data. The outputs of the two paths may be combined through multiplication. The feature path may provide detailed information of a reconstructed high-resolution image and the gating path may remove a ghost artifact by reflecting the importance of each area.

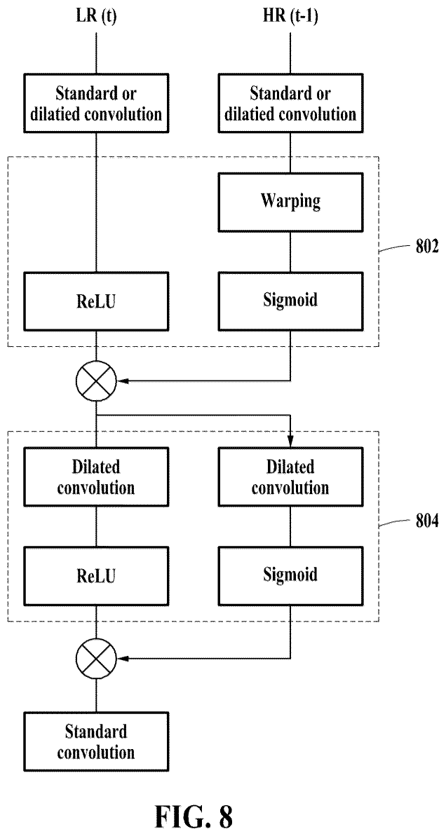

FIG. 8 is a schematic block diagram illustrating a method of applying warping in a feature domain according to an embodiment.

The description provided with reference to FIGS. 1 to 7 may apply to the example of FIG. 8, and a repeated description may be omitted.

Referring to FIG. 8, an example in which warping is applied to a feature domain instead of an image domain and is used as an input to a gating path may be shown. When warping is applied to the input after feature extraction, encoded feature data may be used so that the input accuracy of the gating path may be improved.

The electronic device 1000 according to an embodiment may obtain first feature data and second feature data by extracting a feature of a first image (e.g., LR(t)) and a second image (e.g., HR(t−1)). For example, the electronic device 1000 according to an embodiment may obtain first feature data by extracting a feature of a first image (e.g., LR(t)), and may obtain second feature data by extracting a feature of a second image (e.g., HR(t−1)).

According to an embodiment, one or more gated convolution operations (e.g., the first gated convolution 802 and the second gated convolution 804) may warp the second feature data and may input the warped second feature data to the gating path.

In the feature path, feature extraction from the first image LR(t) may be performed by applying standard convolution or dilated convolution to extract feature data of a low-resolution (LR) image at the time point t.

The extracted first feature data may pass through the ReLU activation function in the gated convolution 802, and nonlinear transformation may be applied thereto.

In the gating path of the gated convolution 802, feature extraction and warping of the second image HR(t−1) may be performed by applying standard convolution or dilated convolution to extract feature data of a high-resolution (HR) image at the time point t−1. Thereafter, the extracted second feature data may be warped to the time point t and may be adjusted to correspond to the current time point.

The warped second feature data may learn the importance of each area by passing through the sigmoid activation function. An output value of the gating path of the gated convolution 802 may be combined with the data of the feature path of the gated convolution 802. As shown in FIG. 8, the output of the gated convolution 802 may be provided to another gate convolution 804, but embodiments are not limited thereto.

The electronic device 1000 may perform sampling in compliance with a standard (e.g., an image processing standard and/or a video processing standard), such as applying jitter, during the process of extracting a feature from the second image as a low-resolution image. For example, when performing a convolution with a kernel size of 6×6, padding parameter d set to d=2, and a stride of two on an HR image, the image size may be reduced by half and a feature of the same size as LR may be extracted. Additionally, when an LR image uses center point sampling, it may be set to align each convolution exactly to a center point by applying the convolution described above. As described above, by appropriately adjusting the size of the convolution kernel and the method of applying padding and stride, a feature of a desired size may be extracted to correspond to a sample point.

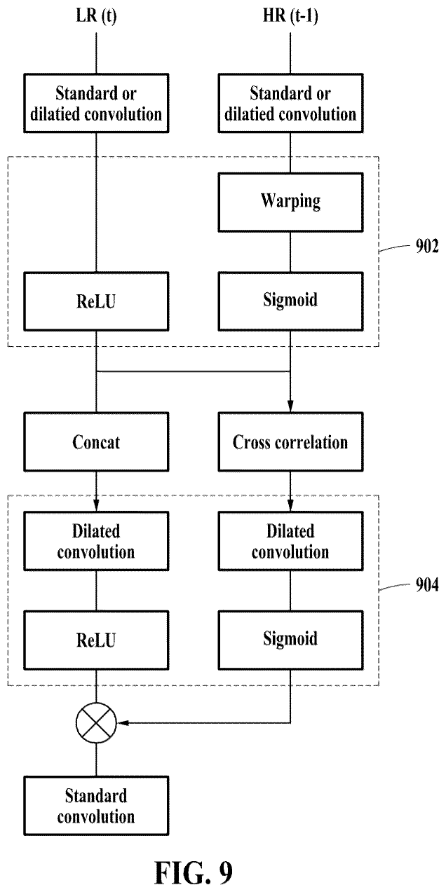

FIG. 9 is a diagram schematically illustrating a gated convolution to which a correlation operation is added according to an embodiment.

The description provided with reference to FIGS. 1 to 8 may apply to the example of FIG. 9, and a repeated description may be omitted.

According to an embodiment, one or more gated convolution operations may perform a concatenation operation (illustrated as “Concat”) on an output of a feature path of a gated convolution 902 and may perform a cross-correlation operation on an output of a gating path of the gated convolution 902.

Similar to FIG. 8, the electronic device 1000 may perform a gated convolution 902 using the generated first feature data and second feature data.

In the cross-correlation operation, a map including a ghost artifact may be generated based on matching by calculating a direct correlation between outputs of the feature path and the gating path of the gated convolution 902. The map may function as a mask to remove a ghost artifact and in a specific disocclusion area, a ghost artifact may be more effectively removed.

The cross-correlation operation may calculate a direct correlation between the feature path and the gating path of the gated convolution 902 rather than simply multiplying outputs of the two paths, and thereby, information that is more optimized to remove a ghost artifact may be generated. The map generated by the cross-correlation operation may be used as input data in the gating path at a next step and through this, in the disocclusion area, a pixel value including a ghost artifact may be more precisely corrected.

The data generated in the feature path and an output of the gating path may be integrated by the concatenation operation. The concatenation operation may preserve features extracted from the two paths as much as possible and may simultaneously reflect a variety of information used to remove a ghost artifact and reconstruct the image quality.

FIG. 10 is a block diagram of an electronic device according to an embodiment.

Referring to FIG. 10, the electronic device 1000 according to an embodiment may include a processor 1030, a memory 1050, and an output device 1070 (e.g., a display). The processor 1030, the memory 1050, and the output device 1070 may be connected to each other via a communication bus 1005.

The output device 1070 may display a rendered image with removed ghost artifacts.

The memory 1050 may store data about the image generation method performed by the processor 1030. In addition, the memory 1050 may store a variety of information generated in a processing process of the processor 1030 described above. In addition, the memory 1050 may store a variety of data and programs. The memory 1050 may include a volatile memory or a non-volatile memory. The memory 1050 may include a large-capacity storage medium such as a hard disk to store a variety of data.

In addition, the processor 1030 may perform at least one method, process, or operation described above with reference to FIGS. 1 to 9 or an algorithm corresponding to the at least one method, process, or operation. The processor 1030 may be a data processing device implemented using hardware including a circuit having a physical structure to perform desired operations. For example, the desired operations may include code or instructions included in a program. The processor 1030 may be configured as, for example, a central processing unit (CPU), a graphics processing unit (GPU), or a neural network processing unit (NPU). For example, the hardware-implemented electronic device 1000 may include a microprocessor, a CPU, a processor core, a multi-core processor, a multiprocessor, an application-specific integrated circuit (ASIC), and a field-programmable gate array (FPGA).

The processor 1030 may execute a program and may control the electronic device 1000. Program codes to be executed by the processor 1030 may be stored in the memory 1050.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or combinations thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods, processes, and operations according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

Although some embodiments have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents, without departing from the scope of the disclosure.

Accordingly, other implementations are within the scope of the following claims.

What is claimed is:

1. A method of generating an image, the method comprising:
obtaining input data based on a first image having a first resolution and a second image having a second resolution that is higher than the first resolution;
generating a third image without a ghost artifact by applying one or more gated convolution operations to the input data using a kernel prediction network;
generating a fourth image by upscaling the first image; and
generating an output image without the ghost artifact based on the third image and the fourth image, wherein the output image has an output resolution that is higher than the first resolution.

2. The method of claim 1, wherein the one or more gated convolution operations comprise one or more dilated convolution operations.

3. The method of claim 1, wherein the one or more gated convolution operations comprise operations for performing gating processing using at least one of a rectified linear unit (ReLU) function and a sigmoid function.

4. The method of claim 1, wherein the obtaining of the input data comprises:
obtaining first input data and second input data based on the first image and the second image;
providing the first input data as input to a feature path included in in the one or more gated convolution operations; and
providing the second input data as input to a gating path included in in the one or more gated convolution operations.

5. The method of claim 4, wherein the first input data comprises geometric information extracted from a rendering result associated with the first image.

6. The method of claim 4, wherein the second input data comprises a difference value indicating a difference between the first image and an image that is obtained by warping a viewpoint of the second image to correspond to a viewpoint of the first image and transforming a resolution of the second image to correspond to a resolution of the first image.

7. The method of claim 1, wherein the obtaining of the input data comprises:
obtaining first feature data and second feature data by extracting a feature from the first image and extracting a second feature from the second image.

8. The method of claim 7, wherein the applying of the one or more gated convolution operations comprises:
warping the second feature data; and
providing the warped second feature data as input to a gating path.

9. The method of claim 8, wherein the applying of the one or more gated convolution operations comprises:
performing a concatenation operation on a feature path; and
performing a cross-correlation operation on the gating path.

10. The method of claim 1, wherein the obtaining of the input data comprises:
transforming the first image into a first grayscale image and transforming the second image into a second grayscale image; and
generating the input data based on the second grayscale image and the first grayscale image,
wherein the first grayscale image and the second grayscale image are space-to-depth transformed.

11. The method of claim 10, wherein the generating of the output image without the ghost artifact comprises:
obtaining a first high-resolution image by performing a depth-to-space transformation operation on the third image.

12. The method of claim 11, wherein the generating of the output image without the ghost artifact comprises:
obtaining a weighted sum of the first high-resolution image, the fourth image, and the second grayscale image.

13. An electronic device comprising:
one or more processors; and
a memory configured to store instructions which, when executed by the one or more processors, cause the electronic device to:
obtain input data based on a first image having a first resolution and a second image having a second resolution that is higher than the first resolution,
generate a third image without a ghost artifact by applying one or more gated convolution operations to the input data using a kernel prediction network,
generate a fourth image by upscaling the first image, and
generate an output image without the ghost artifact based on the third image and the fourth image, wherein the output image has an output resolution that is higher than the first resolution.

14. The electronic device of claim 13, wherein the one or more gated convolution operations comprise one or more dilated convolution operations.

15. The electronic device of claim 13, wherein the one or more gated convolution operations comprise operations for performing gating processing using at least one of a rectified linear unit (ReLU) function and a sigmoid function.

16. The electronic device of claim 13, wherein the instructions, when executed by the one or more processors, further cause the electronic device to:
obtain first input data and second input data based on the first image and the second image,
provide the first input data as input to a feature path included in in the one or more gated convolution operations, and
provide the second input data as input to a gating path included in in the one or more gated convolution operations.

17. The electronic device of claim 16, wherein the first input data comprises geometric information extracted from a rendering result associated with the first image.

18. The electronic device of claim 16, wherein the second input data comprises a difference value indicating a difference between the first image and an image that is obtained by warping a viewpoint of the second image to correspond to a viewpoint of the first image and transforming a resolution of the second image to correspond to a resolution of the first image.

19. The electronic device of claim 13, wherein the instructions, when executed by the one or more processors, further cause the electronic device to:
obtain first feature data and second feature data by extracting a first feature from the first image and extracting a second feature from the second image.

20. A terminal device comprising:
an output device configured to display a real-time rendered image; and
one or more processors configured to perform real-time rendering,
a memory configured to store instructions which, when executed by the one or more processors, cause the terminal device to:
generate an image for removing a ghost artifact from the real-time rendering, and
display an output image without the ghost artifact on the output device,
wherein to generate the image for removing the ghost artifact from the real-time rendering, the instructions, when executed by the one or more processors, further cause the terminal device to:
obtain input data based on a first image having a first resolution and a second image having a second resolution that is higher than the first resolution;
generate a third image without the ghost artifact by applying one or more gated convolution operations to the input data using a kernel prediction network;
generate a fourth image by upscaling the first image; and
generate the output image without the ghost artifact based on the third image and the fourth image, wherein the output image has an output resolution that is higher than the first resolution.
